(19) United States
(12) Patent Application Publication
(10) Pub. No.: US 2024/0327071 A1
(43) Pub. Date: Oct. 3, 2024

(54) CROWN CAP FOR ATTACHMENT TO A MOUTH OPENING OF A CONTAINER COMPRISING FIBERS AND FOR CLOSING THE MOUTH OPENING BY MEANS OF THE CROWN CAP, CONTAINER WITH A CONTAINER BODY COMPRISING FIBERS AND WITH A CROWN CAP, CONTAINER BODY COMPRISING FIBERS, METHOD FOR ARRANGING THE CROWN CAP ON THE CONTAINER BODY COMPRISING FIBERS, AND DEVICE FOR ARRANGING THE CROWN CAP ON THE CONTAINER BODY COMPRISING FIBERS

(71) Applicant: Krones AG, Neutraubling (DE)

(72) Inventors: Ulrich LAPPE, Neutraubling (DE); Barbara WEIN, Gonnersdorf (DE)

(21) Appl. No.: 18/611,558

(22) Filed: Mar. 20, 2024

(30) Foreign Application Priority Data
Mar. 29, 2023 (DE) 10 2023 107 926.3

(51) Int. Cl. B65D 41/10; B65D 1/02; B65D 41/12; B65D 65/46; B67B 3/02

(52) U.S. Cl. CPC B65D 41/105; B65D 1/0207; B65D 1/023; B65D 41/125; B65D 65/466; B67B 3/02

(57) ABSTRACT

The disclosure relates to a crown cap for attachment to a mouth opening of a container body comprising fibers, and for closing the mouth opening by means of the crown cap. The disclosure further relates to a container with a container body comprising fibers and having a mouth opening and with a crown cap, wherein in a closure position the crown cap is attached to the mouth opening and closes the container body. In addition, the disclosure relates to a container body comprising fibers with a mouth opening that can be closed with a crown cap. The disclosure further relates to a method for arranging a crown cap on a container body comprising fibers, wherein the method comprises holding the container body and attaching the crown cap to the mouth opening, and to a device for arranging a crown cap on a container body comprising fibers.

### CROSS REFERENCE TO RELATED APPLICATION

The present application claims priority to German Patent Application No. 10 2023 107 926.3 filed on Mar. 29, 2023. The entire contents of the above-listed application are hereby incorporated by reference for all purposes.

### TECHNICAL FIELD

The disclosure relates to a crown cap for attachment to a mouth opening of a container comprising fibers and for closing the mouth opening by means of the crown cap, a container with a container body comprising fibers with a mouth opening and with the crown cap, a container body comprising fibers, a method for arranging the crown cap on the container body comprising fibers, and a device for arranging the crown cap on the container body comprising fibers.

### BACKGROUND

It is known to close containers containing fibers with screw caps, for example. In this context, plastic can be provided at least partially for the closure and/or for the threaded area of the container. Recycling the material or biodegrading the material or the entire container can be associated with problems.

### SUMMARY

### Object

The object of the disclosure is to provide a crown cap for attachment to a mouth opening of a container body comprising fibers and for closing the mouth opening by means of the crown cap, a container with a container body comprising fibers with a mouth opening and with the crown cap, a container body comprising fibers, a method for arranging the crown cap on the container body comprising fibers, and a device for arranging the crown cap on the container body comprising fibers, which can enable an alternative closing of a container body comprising fibers and a biodegrading and/or composting of the container body.

### Achievement

The object is achieved by the crown cap for attachment to a mouth opening of a container body comprising fibers and for closing the mouth opening by means of the crown cap, the container with a container body comprising fibers with a mouth opening and with the crown cap, the container body comprising fibers, the method for arranging the crown cap on the container body comprising fibers, and the device for arranging the crown cap on the container body comprising fibers, as described herein.

The crown cap according to the disclosure is for attachment to a mouth opening of a container body comprising fibers and for closing the mouth opening by means of the crown cap.

By attaching the crown cap to the mouth opening, the container body can be securely closed without for example having to provide a thread, which can be closable by a screw closure, on the container body. The provision of plastic at least partially for the closure and/or for the threaded area of the container body can also be avoided. Recycling of the container body and/or biodegradation of the container body can be possible.

The crown cap can comprise a metal. For example, the metal can be soft enough for the crown cap to be attached with such force to the mouth opening of a container body comprising fibers without causing damage, such as deformation, to the mouth opening and/or to a mouth area and/or to the container body.

Alternatively or additionally, the crown cap can comprise a material comprising fibers.

The fibers may comprise lignin, banana leaves and/or wild quinine. The fibers may, for example, comprise cellulose fibers, fibers of conifers, of leafy woody plants and/or plane trees and/or grasses, reeds and/or bamboo or the like. The fibers may comprise silk threads, spider silk, algae, natural fibers (such as cup-plant fibers, hemp, maize, cotton), banana peel, orange peel, grass, straw, potato starch or processed cow dung. It is also possible to provide cellulose fibers which originate from a process by which they were artificially grown. In the event of material bottlenecks of wood as the basic material for a fluid mass with fibers, these alternative materials can completely or partially replace the basic material.

The fibers can comprise fiber mixtures of non-wood material, for example cotton, hemp and/or textile fibers.

For example, the fibers may comprise viscose fibers. A viscose fiber is an artificial fiber made of regenerated cellulose, wherein the viscose fibers have, as starting base, 100% cellulose treated in a multi-stage process. The viscose fibers may comprise a flat or cable-shaped structure, a trilobal shape or a double trilobal structure. The fibers may comprise a flat or hollow structure or a corrugated or rough outer surface.

Various types of fibers may also be used in combination. For example, fibers with different outer surfaces and/or shapes and/or hollow structure and/or flat structure and/or of different materials may be combined.

Due to the natural origin of the fibers, they may be biodegradable. In addition, they can be sustainable and renewable.

The fibers may be used in a pulp. The pulp may be or comprise a mixture of water, for example with additives, and fibers.

The container may be a bottle or a can.

The molding of the container body comprising fibers using the fiber-containing pulp can take place in a mold, which can represent a negative form of an outer contour of the container body to be produced, or by means of an injection molding method.

The fiber-containing pulp that is used for molding the container body comprising fibers and the fiber-containing pulp that is used for molding a crown cap can be the same or different.

The crown cap can have been produced by means of 3D printing, for example by using fiber-containing pulp.

A coating of a sealing material can be provided at least on a face of the crown cap that would come into contact with a surface of a mouth area of the container. For example, the coating can be food-safe and/or biodegradable and/or compostable and/or liquid-resistant.

The coating can ensure a seal between at least one surface of the crown cap that would come into contact with a surface of the mouth area of the container body. In addition, the coating can protect the crown cap, for example if it contains fibers, from softening due to absorbed product, the product can be protected from a change in taste due to the crown cap, and/or the sealing tightness of the crown cap in the closure position can then be supported and/or ensured.

A container with a container body comprising fibers with a mouth opening and with a crown cap, as described above or below, is provided, wherein in a closure position the crown cap is attached to the mouth opening and closes the container body.

The container body can comprise a mouth area that can be held by a clamp for holding. The mouth area can be held by the clamp in order to ensure stabilization when the crown cap is attached to the mouth opening of the container body comprising fibers.

The mouth opening can comprise a rim. In a closure position, the crown cap can at least partially grip around the rim.

A dimension of the crown cap and a dimension of the mouth opening can be made in such a way that the crown cap is attachable to the mouth opening of the container body comprising fibers for closing and that the mouth opening can be closed by means of the crown cap.

A container body comprising fibers with a mouth opening that can be closed with a crown cap as described above or further below is provided.

The container body can further comprise a mouth area that can be held by a clamp for holding. For example, the mouth area can comprise a rim.

A method for arranging a crown cap as described above or further below on a container body comprising fibers as described above or further below comprises holding the container body and attaching the crown cap to the mouth opening.

The holding can comprise holding at the mouth area of the container body.

The attaching can comprise placing the crown cap over the mouth opening and exerting a force substantially parallel to a longitudinal axis of the container body from outside the container body toward the mouth opening.

The attaching can comprise a crimping of the crown cap onto the mouth opening by exerting a force substantially radially toward a longitudinal axis of the container body.

By attaching the crown cap to the mouth opening, the crown cap can form a fixed but detachable connection with the mouth area so that the container body can be closed.

From the closure position, the crown cap can be brought into an open position away from the container body. In general, the crown cap is not a repeatedly used closure. It can usually be placed on the mouth opening again, but it then no longer has a closing function.

Attaching can further comprise drying and/or solidifying a material of the crown cap by heating the crown cap during attachment. This can be expedient, for example, if the crown cap comprises fibers.

A device for arranging a crown cap as described above or further below on a container body comprising fibers as described above or further below is provided.

### BRIEF DESCRIPTION OF FIGURES

The accompanying figures show, by way of example, aspects and/or exemplary embodiments of the disclosure for better understanding and illustration. In the figures:

FIG. 1 is an oblique view of a crown cap for attachment to a mouth opening of a container body comprising fibers and for closing the mouth opening by means of the crown cap,

FIG. 2 is a cross-section through the crown cap and a mouth area of the container body comprising fibers, and

FIG. 3 is a cross-section through the crown cap attached to the mouth opening of the mouth area.

### DETAILED DESCRIPTION OF FIGURES

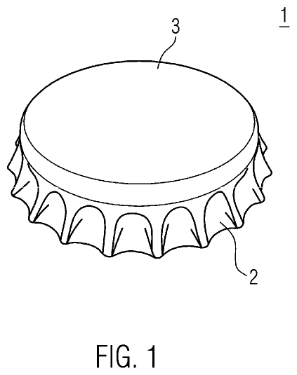

FIG. 1 shows an oblique view of a crown cap 1 for attachment to a mouth opening of a container body comprising fibers and for closing the mouth opening by means of the crown cap 1. The illustration shows an upper side 3 of the crown cap 1 and a first fold 2. The first fold 2 shows the state when the crown cap has not yet been attached to a mouth opening.

The crown cap 1 can comprise a metal that is for example soft enough for the crown cap 1 to be attached with such force to the mouth opening of a container body comprising fibers without causing damage, such as deformation, to the mouth opening and/or to a mouth area and/or to the container body.

The crown cap 1 can also or alternatively comprise a material comprising fibers. A fiber-containing pulp can be used to produce the crown cap 1, wherein 3D printing can be used to form the crown cap 1.

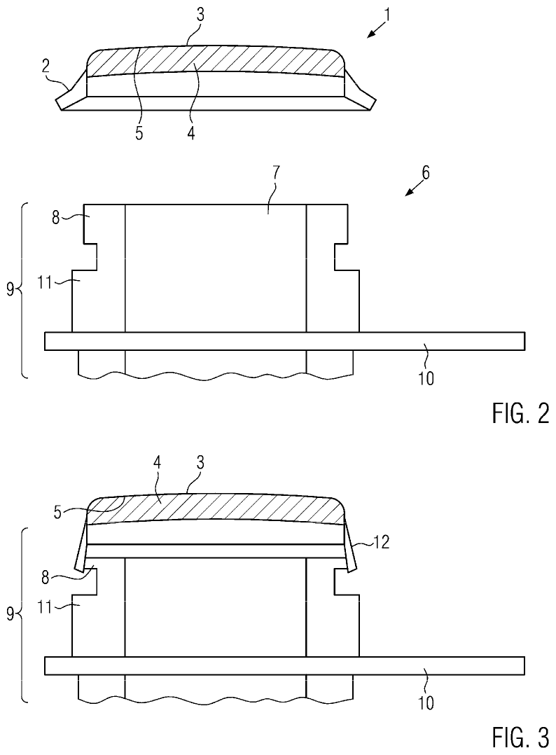

FIG. 2 shows a cross-section through the crown cap 1 and a mouth area 9 of the container body 6 comprising fibers. The crown cap 1 comprises a coating 4 on an inner surface 5. The coating 4 can consist of a sealing material, wherein the coating 4 can be food-safe and/or biodegradable and/or compostable and/or liquid-resistant. The coating 4 can ensure a seal between at least one surface of the crown cap 1 that would come into contact with a surface of the mouth area 9 of the container body 6. In addition, the coating 4 can protect the crown cap, for example if it contains fibers, from softening due to absorbed product, the product can be protected from a change in taste due to the crown cap, and/or the sealing tightness of the crown cap in the closure position can then be supported and/or ensured.

The mouth area 9 of the container body 6 comprising fibers surrounds the mouth opening of the container body 6 and has a rim 8 and a reinforcement 11. The mouth area 9 is held by a clamp 10 in order to ensure stabilization when the crown cap 1 is attached to the mouth opening 7 of the container body 6 comprising fibers.

FIG. 3 shows a cross-section through the crown cap 1 attached to the mouth opening 7 of the mouth area 9 of the container body 6 comprising fibers, and through the mouth area 9. The illustration corresponds to a closure position of the crown cap. By attaching the crown cap 1 to the mouth opening 7, the crown cap 1 now has a second fold 12 that forms a fixed but detachable connection with the mouth area 9, so that the container body 6 is closed. The second fold 12 shows the state when the crown cap 1 has been attached to the mouth opening 7.

The attaching of the crown cap 1 to the mouth opening 7 can comprise a placing of the crown cap 1 over the mouth opening 7 and exerting a force substantially parallel to a longitudinal axis of the container body 6 from outside the container body 6 in the direction toward the mouth opening 7.

Or the attaching of the crown cap 1 to the mouth opening 7 can comprise a crimping of the crown cap 1 onto the mouth opening 7 by exerting a force substantially radially toward a longitudinal axis of the container body 7.

If the crown cap 1 comprises fibers, the attaching can further comprise drying and/or solidifying a material of the crown cap 1 by heating the crown cap 1 during attachment.

From the closure position, the crown cap 1 can be brought into an open position away from the container body 6. In general, the crown cap is not a repeatedly used closure. It can usually be placed on the mouth opening 7 again, but it then no longer has a sealing function.

1. A crown cap for attachment to a mouth opening of a container body comprising fibers and for closing the mouth opening by means of the crown cap.

2. The crown cap according to claim 1, wherein the crown cap comprises a metal.

3. The crown cap according to claim 1, wherein the crown cap comprises a material comprising fibers.

4. The crown cap according to claim 3, wherein the crown cap was produced by means of 3D printing.

5. The crown cap according to claim 1, wherein a coating of a sealing material is provided at least on a surface of the crown cap that would come into contact with a surface of a mouth area of the container body.

6. A container having a container body comprising fibers, with a mouth opening and with a crown cap according to claim 1, wherein in a closure position the crown cap is attached to the mouth opening and closes the container body.

7. The container according to claim 6, wherein the container body comprises a mouth area that can be held by a clamp for holding.

8. The container according to claim 7, wherein the mouth area comprises a rim.

9. The container according to claim 6, wherein a dimension of the crown cap and a dimension of the mouth opening are made such that the crown cap is attachable to the mouth opening of the container body comprising fibers for closing and that the mouth opening is closed by means of the crown cap.

10. A container body comprising fibers, having a mouth opening that can be closed with a crown cap according to claim 1.

11. The container body according to claim 10, wherein the container body further comprises a mouth area that can be held by a clamp for holding.

12. A method for arranging a crown cap according to claim 1 on a container body comprising fibers, the crown cap for attachment to a mouth opening of the container body and for closing the mouth opening by means of the crown cap, wherein the method comprises:
holding the container body,
attaching the crown cap to the mouth opening.

13. The method according to claim 12, wherein the holding comprises a holding at the mouth area of the container body.

14. The method according to claim 12, wherein the attaching comprises:
placing the crown cap over the mouth opening and exerting a force substantially parallel to a longitudinal axis of the container body from outside the container body in the direction toward the mouth opening.

15. The method according to claim 12, wherein the attaching comprises:
crimping the crown cap onto the mouth opening by exerting a force substantially radially toward a longitudinal axis of the container body.

16. The method according to claim 12, wherein the attaching further comprises:
drying and/or solidifying a material of the crown cap by heating the crown cap during attachment.

17. The crown cap of claim 5, wherein the coating is food-safe and/or biodegradable and/or compostable and/or liquid-resistant.

18. The container body of claim 11, wherein the mouth area comprises a rim.
